(19) United States
(12) Patent Application Publication
(10) Pub. No.: US 2006/0285323 A1
(43) Pub. Date: Dec. 21, 2006

(54) Lighting device

(75) Inventor: James Andrew Fowler, Bradford (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: OPTILUME LTD, Ilkley (GB)

(21) Appl. No.: 11/339,288

(22) Filed: Jan. 25, 2006

(30) Foreign Application Priority Data
Jun. 16, 2005 (GB) 0512256.9

(51) Int. Cl. F21S 9/00

(52) U.S. Cl. 362/230

(57) ABSTRACT

A lighting device can include a housing having a viewing axis and at least one light source. The light source can be comprised of at least one LED, and can be configured to emit light having a spectrum that approximates a noon-day sunlight spectrum. The light source can be disposed in or coupled with the housing, and oriented with respect to the housing so that the emitted light has an angle of incidence from about 15 degrees to about 75 degrees. Thus, the emitted light can have an angle from about 15 degrees to about 75 degrees with respect to the viewing axis. The lighting device can be used to compare the color of different materials having different compositions. Also, the lighting device can be used to illuminate objects that are sensitive to IR and/or UV light.

### CROSS-REFERENCE TO RELATED APPLICATIONS

This application claims the benefit of United Kingdom Patent Application Number 0512256.9, filed on Jun. 16, 2005, with James Andrew Fowler as inventor, the disclosure of which is incorporated herein in its entirety.

### BACKGROUND OF THE INVENTION

1. The Field of the Invention

The present invention relates to a lighting device. More particularly, the present invention relates to a lighting device and method of illumination that utilizes light from an LED source that simulates noon-day sunlight.

2. The Related Technology

The accurate illumination of teeth and a dental restorative material can be important in dental applications. In part, this is because the color of the dental restorative material being used to repair the teeth should be closely matched with the patient's teeth so that the dental restoration looks natural. Conventionally, such color matching has been performed by taking the patient to a source of daylight, such as a window, and matching the color of the dental restorative material with the color of the patient's teeth. During this procedure, the dental professional is generally trying to obtain a light source of about 5500 Kelvin (i.e., a measure of color temperature), which is generally held to be a standard that most closely corresponds to “noon” sunlight or the level of daylight at the brightest point in a day. However, this method is susceptible to error, and is typically dependent on factors such as the time of day at which the color matching is undertaken, the amount of daylight available, and/or the weather. In addition, it is inconvenient to have to restrict color matching to particular times of the day, weather conditions, or locations near windows. If the color matching is incorrect, the patient may have purchased (at high cost) crowns, fillings, and/or the like that do not match the natural color of their teeth. Dental restorations that do not match the natural color of surrounding teeth can be aesthetically displeasing and distressing to the patient.

One method currently used to overcome this problem is to use a fluorescent light source such as a lighting cabinet incorporating one or more fluorescent light sources that purportedly simulate sunlight. However, such lighting cabinets do not actually produce light comparable to daylight, particularly noon-day sunlight. In addition, the fluorescent light sources have to heat up for a pre-determined period of time before the light being emitted therefrom has a stable color spectrum. Also, fluorescent lights have a relatively limited and short lifespan and/or degrade in color accuracy over time. As such, these conventional devices can result in inaccurate color matching or shade matching between the dental restoration and surrounding teeth.

Therefore, it would be advantageous to have a lighting device which provides a more accurate illumination source that emits light simulating a noon-day sunlight spectrum. Additionally, it would be beneficial to have a method of analyzing colors with the simulated noon-day sunlight spectrum.

### SUMMARY OF THE INVENTION

Generally, the foregoing problems, including the need for an illumination source that simulates noon-day sunlight, as well as other similar needs in the art, can be solved with an embodiment of the present invention. Accordingly, an embodiment of the present invention can include a lighting device comprised of a housing having a viewing axis. The housing can include or be coupled to a light source comprised of at least one light emitting diode (“LED”), which can include a white LED. The light source can be configured to emit light having a spectrum that approximates a noon-day sunlight spectrum. Also, the light source can be oriented with respect to the viewing axis so that the emitted light is oriented from about 15 degrees to about 75 degrees with respect to the viewing axis, preferably about 45 degrees relative to the viewing axis.

In one embodiment, the present invention includes a method of illuminating an object. The method can include obtaining a lighting device as described herein, which is comprised of at least one LED and is configured to emit light having a spectrum that approximates a noon-day sunlight spectrum. The LED can be part of a light source that is oriented from about 15 degrees to about 75 degrees with respect to a viewing axis. Subsequently, the viewing axis can be positioned substantially orthogonal with an object to be illuminated so that the emitted light is directed at the object at about 15 degrees to about 75 degrees when the object is at 90 degrees with respect to the viewing axis. The object can then be illuminated with the lighting device, and the object can be viewed along the viewing axis.

In one embodiment, the present invention includes a method of analyzing the color of different materials. Such a method can include illuminating a first composition and a second composition with at least one light source. The light source can have at least one LED, which can be a white LED used alone or in combination with a blue and/or red LED. The light source can be configured to emit a light beam having a spectrum that approximates a noon-day sunlight spectrum. The light source can be used to compare the colors of compositions having different chemical make-up so that any differences in color, even if minor, can be accurately distinguished under consistent and reproducible lighting conditions. Accordingly, a first color of the first composition and a second color of the second composition can be viewed under the light beam, and a comparison can be made between the first color and the second color.

In an embodiment, the light source is used to illuminate a person's teeth and any prosthetic or artificial teeth or compositions in order to accurately compare their respective coloring. The light can be used to examine other colored objects, such as textiles.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings, in which:

FIG. 1A is a schematic diagram that illustrates spectrally and diffusely reflected light;

FIG. 1B is a schematic diagram that illustrates spectrally reflected light that interferes with a viewing area;

FIG. 2 illustrates a noon-day sunlight spectrum;

FIG. 3 illustrates a conventional fluorescent spectrum that purports to approximate noon-day sunlight;

FIGS. 4A-4B illustrate embodiments of improved noon-day sunlight spectrums that can be obtained with embodiments of the present invention.

FIG. 5 is a front view that illustrates of an embodiment of a lighting device;

FIG. 6 is a cross-sectional side view that illustrates the lighting device in FIG. 1;

FIG. 7 is a rear view that illustrates the lighting device in FIG. 1; and

FIG. 8 a side view that illustrates an embodiment of a lighting device.

### DETAILED DESCRIPTION OF THE PREFERRED EMBODIMENTS

Generally, the present invention includes a lighting device and method of use for illuminating an object with light that simulates noon-day sunlight. This is because light that simulates noon-day sunlight can illuminate an object so that the visible color is more accurate and reproducible. Also, colors that appear to be similar in certain lighting conditions can be more easily distinguished under light that simulates noon-day sunlight. This can be advantageous in the dental, surgical, cosmetic, agricultural, and textile industries, as well as in other similar industries where accurate color delineations may be needed.

The lighting device and method uses a light source that includes LEDs. One or more LEDs can be tuned by varying the current, by using filters or combining different LEDs so that light emitted from the light source can simulate the noon-daylight spectrum. Additionally, LEDs can be advantageous in that they do not generate a substantial amount of heat, and can be placed close to an object being viewed. This can be helpful for distinguishing the color of small items and for uses where heat generated by a light in the form of Infra Red radiation can have adverse effects such as in examining cell cultures or expensive paintings.

I. Reflected Light

The lighting device can be configured such that the emitted light is directed at an object at an angle that inhibits specularly reflected light from interfering with the accuracy of the observed color. This allows the diffusely reflected light to exhibit the color of the object without interference from the specularly reflected light. The terms “specularly reflected light” or “specular reflection” are meant to refer to the light beam that is reflected at an angle of reflection that is approximately equal to the angle of incidence of the emitted light. Specular reflection is sometimes manifested as glare, which can greatly alter or obscure the color of the object being illuminated. On the other hand, the terms “diffusely reflected light” or “diffuse reflection” are meant to refer to the light or multiple beams of light that are reflected in a distribution over a wide range of angles. Thus, a specular reflection correlates with the incident light beam and the diffuse reflection correlates with the color of the object being illuminated.

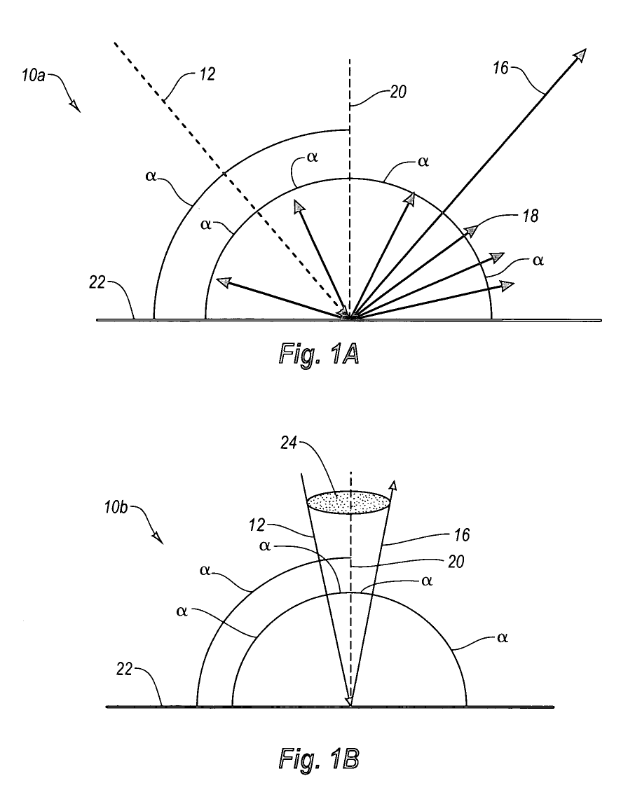

FIG. 1A is a schematic diagram that represents a reflection pattern 10 of incident light 12 when reflected from a surface 22 of an object being illuminated. As shown, the incident light 12 strikes the surface 22 so that the angle of incidence is α with respect to a viewing axis 20. Also, the incident light 12 has an angle β with respect to the surface 22. The viewing axis 20 is shown to be at an angle γ with respect to the surface 22, wherein angle γ is usually about 90 degrees or substantially orthogonal with the surface. Accordingly, the specularly reflected light 16 reflects from the surface 22 at an angle of reflection of α with respect to the viewing axis 20. Also, the specular light 16 has an angle β with respect to the surface 22. On the other hand, the diffuse light 18, which is represented by a plurality of short arrows, is reflected from the surface at all angles.

FIG. 1B is a schematic diagram that represents a reflection pattern 24 that interferes with the color of the object. As shown, the incident light 12 has an angle of incidence α that is narrow and at the edge of the field of view 24. The field of view 24 is characterized as the viewing area that surrounds the viewing axis. As such, the field of view correlates to the cross-sectional area of the light that is observed when viewing the surface 22. Correspondingly, the specular reflection 16 also has an angle of reflection α that is narrow and at the edge of the field of view 24. In the instance the specular reflection 16 is close to or within the field of view the color of the surface can be distorted by the specular light. This can cause the observed color to be different from the color shown by the diffusely reflected light.

It has been found that an angle of incidence α and corresponding angle of reflection α that is less than about 15 degrees can interfere with observed color. This is because specularly reflected light having an angle of reflection less than about 15 degrees can interfere with the field of view. In some instances, angles of reflection of up to 25 degrees or 35 degrees can also compromise the observed color. As such, it can be preferable for the angle of incidence to be greater than about 15 degrees, more preferably greater than 25 degrees, and most preferably greater than 35 degrees. An angle of incidence that has been found to be optimal is 45 degrees.

II. Light Spectra

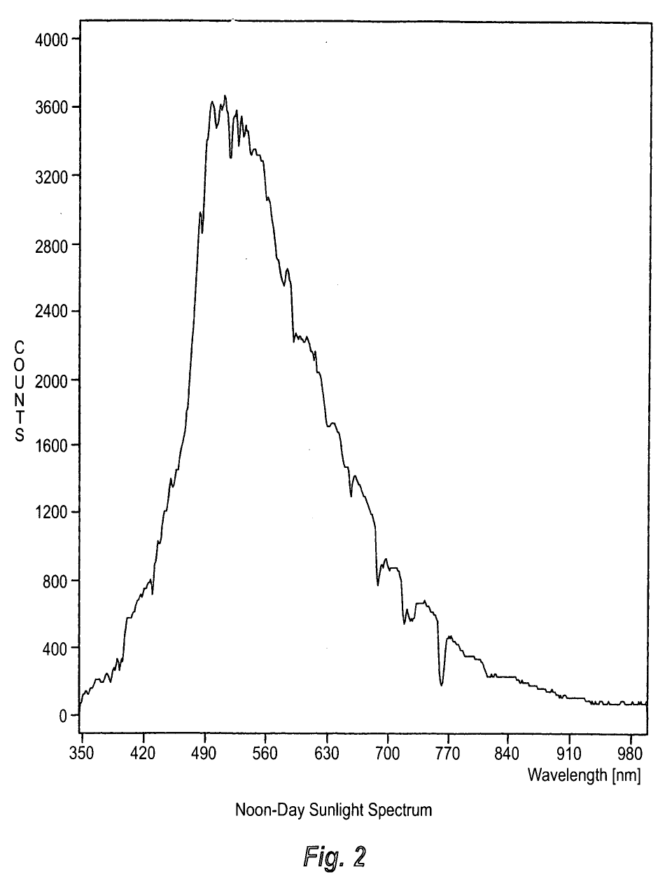

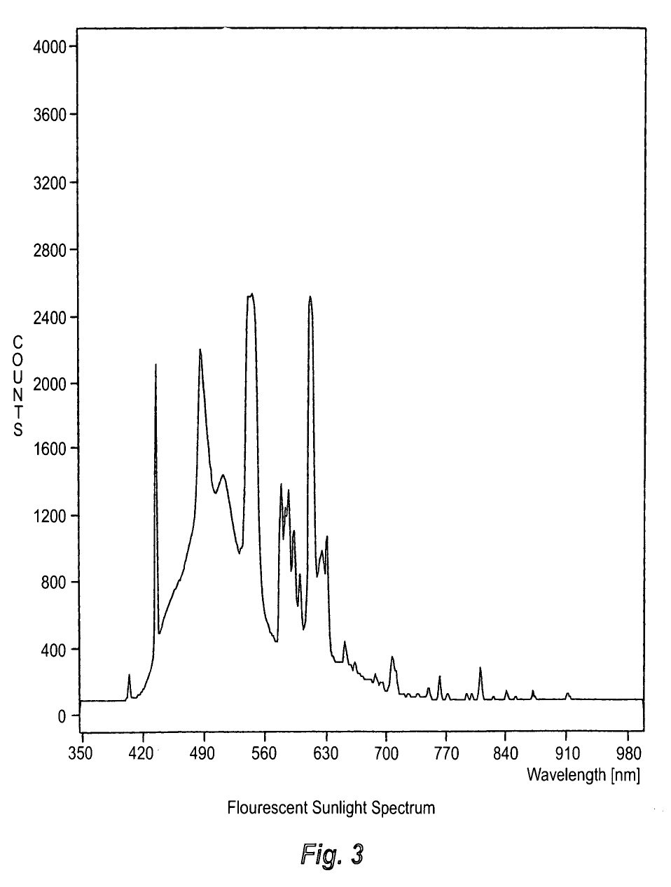

A problem in color analysis arises from the spectrum of light used to illuminate an object. In part, this is because different light spectra can cause the same color to appear differently. Accordingly, noon-day sunlight has been adopted as a standard spectrum for color analysis. This has resulted in limited times colors can be analyzed with sunlight; however, clouds or other shading can also affect the spectrum of noon-day sunlight. FIG. 2 is a graph of the noon-day sunlight spectrum which is characterized as about 5,500 Kelvin (“K”). Briefly, the Y-axis shows the counts of light and the X-axis shows the wavelength of light (e.g., nm). Fluorescent lights have been configured to simulate sunlight, but are problematic in requiring a warm-up period and emitting a substantial amount of heat and light spectrums that change over time. FIG. 3 is a graph of a fluorescent light that purportedly simulates the noon-day sunlight spectrum.

In one embodiment, the light source of the present invention uses LED light in order to better simulate the noon-day sunlight spectrum than a fluorescent light. LED lights are beneficial in that they do not need a long time to warm up, do not emit a substantial amount of heat, and have significantly longer lives without changes in the emitted spectrum compared to fluorescent lights.

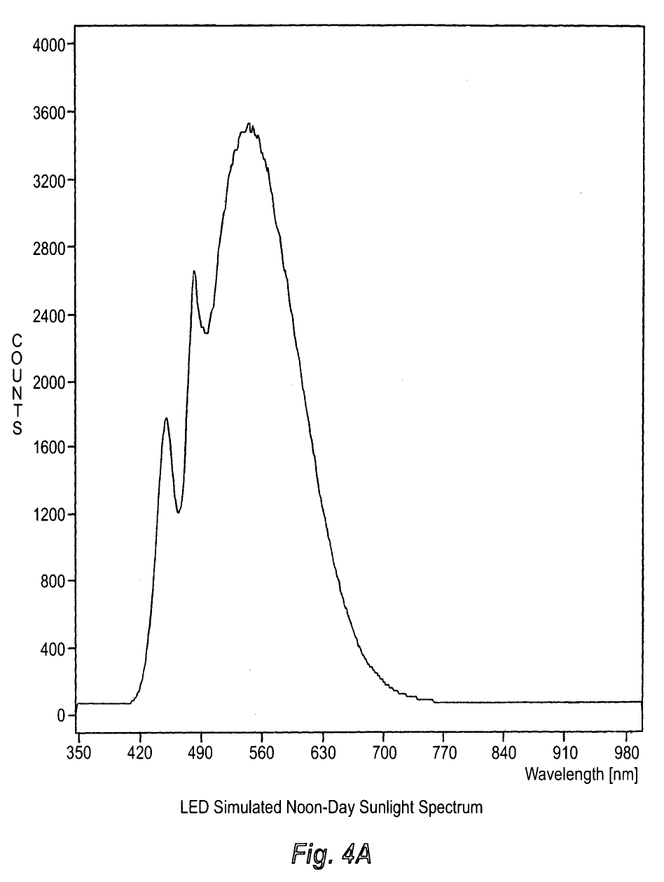

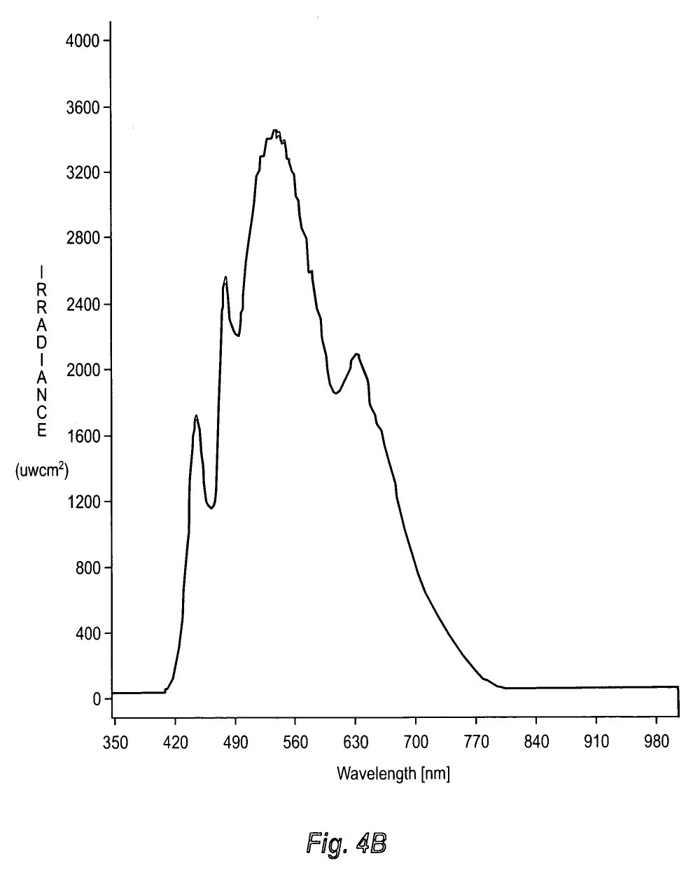

FIGS. 4A-4B illustrate simulated noon-day sunlight spectrums that can be obtained using different combinations of LEDs. More particularly, FIG. 4A illustrates an LED-simulated noon-day sunlight spectrum that can be produced by tuning the light emitted with a white LED by employing an additional blue LED having a peak wavelength of about 470 nm. Accordingly, the LED-simulated noon-day sunlight spectrum more closely resembles the noon-day sunlight spectrum of FIG. 2 compared to the light spectrum produced for a conventional fluorescent sunlight source, as shown in FIG. 3.

Additionally, a red LED can be used in combination with the white LED or with white and blue LEDs in order to improve the accuracy of the simulated noon-day sunlight spectrum (e.g., about 5500 K) and to improve the color rendering index. A similar method to that described above can be used to correct the light spectrum. The red LED typically has a peak wavelength of 627 nm. Accordingly, FIG. 4B illustrates an LED-simulated noon-day sunlight spectrum that can be produced by tuning the light emitted with a white LED by employing additional blue and red LEDs. As such, the blue LED can provide a correction peak wavelength less than that of white light and the red LED can provide a correction peak wavelength above that of white light. Thus, the present invention can use LEDs in the light source for color comparisons, shade taking, and/or for providing a more accurate illumination source that simulates sunlight.

The present invention has the advantage that the arrangement of the light source and geometry of the same can provide accurate illumination, and typically without specular reflection toward the viewer. The LEDs used in the lighting device generally have a substantially longer lifespan than other light sources. For example, the LEDs used in the present invention can last for up to 100,000 hours of operation. The light emitted from the LEDs does not substantially decay over time, and the LEDs do not require a pre-determined period of time before use to allow the light source to warm up before stable light is produced, as is the case with prior art lighting devices. They also maintain their color over time.

In addition, the color rendering index produced by the present invention is significantly improved compared to conventional devices and the resulting light spectrum can more closely simulate noon-day sunlight. As such, the spectrum can be characterized as being from about 5200 K to about 6600 K, more preferably from about 5400 K to about 6000 K, and most preferably about 5500 K.

III. Lighting Device

One embodiment of the present invention is a lighting device that simulates daylight. The lighting device can include a housing that has at least one light source for illuminating a surface and a viewing aperture for allowing a user to view the surface. Alternatively, the at least one light source can be in a separate housing that is couplable with the housing that includes the viewing aperture. Usually, the viewing aperture has a cross-sectional area that forms a plane that is congruent with the cross-section of the housing. Also, the viewing aperture can include a viewing axis that extends therethrough so as to be substantially orthogonal with the plane of the viewing aperture. The light source is configured to emit a beam of light that has an angle of incidence (e.g., α) with respect to the viewing axis. The angle of incidence is oriented so as to substantially inhibit specular reflections from entering the viewing aperture. Usually, the angle of incidence ranges from about 15 degrees to about 75 degrees with respect to the viewing axis, wherein the viewing axis is considered to be at about 0 degrees.

A. LEDs

In one embodiment, at least one light source can include at least one LED. A single color LED light source typically does not generate a correct daylight spectrum. As such, the LED can be tuned so as to provide a spectrum more closely resembling a normal daylight spectrum, such as a noon-day sunlight spectrum. For example, the light source can be configured to simulate the light spectrum of FIG. 2, which is shown by FIGS. 4A and 4B. Usually, at least one LED includes a white LED, which provides a light characterized as 5000 K. Accordingly, the tuning can be accomplished by conditioning the light emitted by at least one LED so that light source appears to emit light that simulates noon-day sunlight, which can be characterized as about 5500 K.

In one embodiment, the LED light can be conditioned to simulate noon-day sunlight by using a filter or combination of filters. Optical filters are well known in the art, and can be configured to inhibit the passage of selected wavelengths, which can be used to produce a desired spectrum. Furthermore, the LED light can be conditioned by the additional use of at least one blue LED and/or at least one red LED. Additionally, the spectrum of LED light can be adjusted by modulating the current that drives the emission of light. This can include adjusting the current that drives the emission of light from the white LED, blue LED and/or red LED so that when combined with a white LED, the emitted light simulates noon-day sunlight. Thus, the white, blue, and/or red LEDs can be used to improve the color rendering index of the lighting device, and can be used in combination with an optical filter.

In one embodiment, the light source includes a combination of LEDs as follows: (a) blue and white LEDs; (b) red and white LEDs; or (c) blue, red and white LEDs. Preferably the LEDs include at least one blue LED, at least one red LED, and at least one white LED. Any number of white, blue and red LEDs can be provided as the light source. Preferably, the ratio of blue and white LEDs is equal (e.g., 1:1 or 2:2). Also, the ratio of white and red LEDs is preferably equal (e.g., 1:1 or 2:2). Similarly, the ratio of white, blue, and red LEDs is preferably equal or constant (e.g., 1:1, 2:2). Alternatively, any ratio of white, red and/or blue LEDs can be provided in the light source that simulates noon-day sunlight.

In one embodiment, the light source can include a plurality of LEDs that are located close together. Optionally, the LEDs can be touching or substantially touching. Alternatively, the LEDs in a single light source can be spread apart or substantially separated. In either case, the light source can include an optical blender, such as a diffuser, which can be used to blend the light to form an appropriate illumination beam. Such blending can also be obtained without the use of an optical blending. In any event, the LEDs can combine to form a beam of light emitted from the light source that simulates noon-day sunlight.

In one embodiment, the lighting device includes at least two light sources. As such, each light source can include single colored LEDs, such as white, blue, or red LEDs. Accordingly, the at least two light sources can emit light that is combined before or at the surface of the object so as to simulate the noon-day sunlight spectrum. This can allow for multiple light sources to cooperate in order to simulate the noon-day sunlight spectrum.

B. Spectrum Tuning

In one embodiment, the spectrum or color temperature of the light emitted from the light source can be tuned. This allows for the spectrum or temperature of the light to be adjusted as desired or needed. For example, the spectrum of light emitted by the light source may deviate from the noon-day sunlight spectrum over time, and tuning the spectrum can re-achieve the desired spectrum. Also, the spectrum can be tuned and adjusted during manufacturing. Alternatively, there may be situations where light that does not approximate the noon-day sunlight spectrum is desired or needed, where tuning may alter the spectrum away from noon-day sunlight.

In one embodiment, the spectrum can be tuned by varying the current passing through the LED. This can be done for white, blue, and/or red LEDs until a desired color spectrum is achieved. Accordingly, the current can be varied through the white, blue, and/or red LEDs using any suitable electrical circuitry and/or other known device for adjusting currents. Also, a spectroradiometer can be used to measure the spectrum of the emitted light so that it can be tuned or adjusted to a desired spectrum.

For example, during manufacture of the lighting device, the white, blue, and/or red LEDs can be tuned until a suitable light spectrum is produced by the combination of LEDs. The LEDs can be individually tuned or tuned together. The LEDs are tuned by changing the intensity of illumination produced by the individual LEDs until the desired spectrum is obtained. Tuning can be achieved by varying the current passing through the LEDs until the desired spectrum is achieved for the light source. Similar tuning can be performed post-manufacture.

C. Viewing Aperture

In one embodiment, the lighting device can include a viewing aperture for viewing the illuminated object therethrough. This can allow for the viewing aperture to include a viewing axis extending therethrough so as to be substantially orthogonal with the viewing aperture and/or an object being viewed. Alternatively, the viewing aperture can be substituted with any other structure or device that can be used to view the illuminated object, such as sights or the like, that include a viewing axis and field of view.

The viewing aperture can be an empty conduit that merely passes light therethrough, or it can include various optical devices. As such, the optical devices can be any of one or more windows, lenses, magnifying lenses, reducing lenses, lenses with concave surfaces, lenses with convex surfaces, lenses with flat surfaces, diffusers, collimators, filters, reflectors, reflective materials to inhibit specular reflections, combinations thereof, and the like. Also, the optical devices can be comprised of any suitable translucent glass, plastic, and/or the like.

The housing surrounding and/or defining the viewing aperture can be colored so as to inhibit any alteration of the color of the object being viewed therethrough. As such, it can be colored 18% grey. This can include a rear surface surrounding the viewing aperture and/or the aperture wall having a grey color.

D. Light Source Cooling

The lighting device can include a cooling device or structure. The cooling device or structure can be used to prevent overheating of the housing and/or light source, as well as regulate the temperature of the lighting device. The cooling device or structure can include any of one or more fans, heat sinks, vents, fins, apertures, and/or the like. Cooling devices or structures are well known in the art.

Regulating the temperature of the lighting device can enable use in temperature-sensitive environments. Accordingly, this allows the lighting device to be placed proximate to the surface of a subject being illuminated, which can include skin, teeth, hair, wounds, surgical openings, temperature sensitive materials, and the like. Also, temperature regulation can allow the lighting device to be hand-held or manually manipulated.

E. Multiple Light Sources

In one embodiment, the lighting device can include at least two light sources. For example, the light sources can be provided on opposite sides of the viewing aperture to provide more complete illumination of the subject. However, the light sources can be oriented in any manner so as to cooperate in illuminating an object. Each light source is typically provided at an angle of incidence as described herein. For example, each light source can emit light at approximately 45 degrees with respect to the viewing axis. The use of at least two light sources can avoid specular reflections that cause the reflected light to alter the color of an object viewed.

IV. Exemplary Lighting Devices

In accordance with the foregoing, the present invention includes a lighting device that uses LEDs in order to simulate noon-day sunlight. The lighting device can have various configurations as needed, which can include being portable, hand-held, couplable to a support or stand, or mountable to any surface. While exemplary lighting devices are described in more detail below, various modifications can be made thereto within the scope of the present invention. Also, well-known features of LEDs and lights using the same can be employed in the present invention.

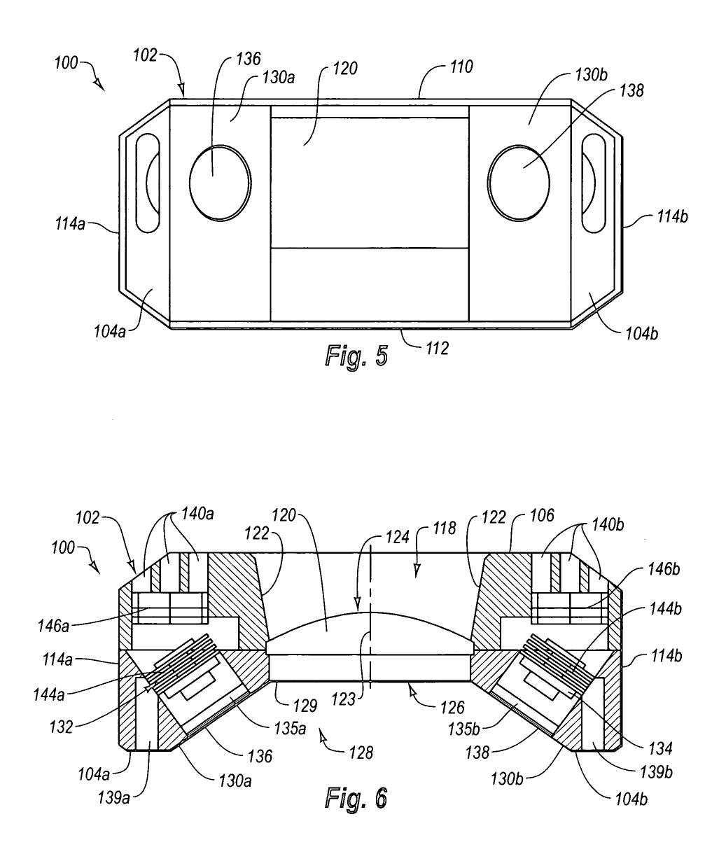

FIGS. 5-7 are schematic diagrams depicting an embodiment of an exemplary lighting device 100. Accordingly, elements depicted and described in connection with any of FIGS. 5-7 may also be included in the other figures without specific reference. The lighting device 100 is configured to emit light that simulates noon-day sunlight as described herein. Such a lighting device 100 can be used in accordance with the present invention for color analysis, shade taking, or comparing colors of different materials.

Generally, the lighting device 100 includes a housing 102, a first light source 132, and a second light source 134. However, the lighting device can have only one light source 132 or more than two lighting sources, wherein corresponding modifications to the lighting device 100 are self-evident.

As shown in FIGS. 5-6, the housing 102 includes a pair of front surfaces 104a-b, a rear surface 106, a pair of side walls 110 and 112, and a pair of end walls 114a-b. Additionally, the front surfaces 104a-b can be separated by a recess 128 having a pair of recess walls 130a-b. The recess walls 130a-b can have a narrowing taper from front surfaces 104a-b toward a base surface 129. More specifically, the recess walls 130a-b can be provided at an angle of about 45 degrees with respect to the base surface 129. Additionally, a viewing aperture 118 can extend from the base surface 129 to the rear surface 106. The housing 102 can be made of any suitable material, such as ceramics, plastics, and metals, wherein plastics are preferred because of cost and ease of manufacture. The housing 102 can be shaped as illustrated in FIG. 5; however, the shape of the device can be modified as long as the function of illuminating objects so as to inhibit spectral reflections can be retained. The housing 102 can be any size depending on the intended use, but it may be advantageously relatively compact and can be handheld and/or can be attached to a suitable support.

As shown in FIG. 6, the viewing aperture 118 can be defined by at least one aperture wall 122. The viewing aperture 118 can have a substantially consistent cross-sectional area, or it can have a positive or negative taper from the base surface 129 to the rear surface 106. The viewing aperture 118 can include a viewing axis 123 extending therethrough. The viewing axis 123 generally describes the line of sight for use in viewing an object that has been illuminated with the lighting device 100. Additionally, the viewing aperture 118 can include various optical devices that can improve the image of the object being viewed. Such optical devices include lenses, magnifying lenses, and the like. As depicted, the viewing aperture 118 includes a magnifying lens 120. Also, the aperture wall 122 is tapered inwardly away from rear surface 106 so as to increase the ease of viewing an object through the lens 120.

The lens 120 can have a convex surface 124 that is oriented toward the rear surface 106, and a substantially flat or planar surface 126 oriented toward the base surface 129 and the front surfaces 104a-b. Optionally, the lens 120 can be incorporated into an optical device (not shown) that can be removably inserted into the viewing aperture 118. The lens 120 can be coupled with the aperture wall 122 or otherwise retained within the viewing aperture 118.

In one embodiment, the lighting device 100 can include a magnifying mechanism (not shown), which can allow for the magnification to be adjusted. Such a magnifying mechanism can include a various lenses that are configured to increase or decrease the magnification and are well known in the art. Additionally, the lighting device 100 can include a focusing mechanism (not shown). The focusing mechanism can be configured to focus the image of the object being viewed through the lens 120. Focusing mechanisms are well known in the art.

In one embodiment, the lighting device 100 can include two light sources 132, 134 disposed within the housing. Alternatively, the light sources 132, 134 can be coupled with the housing or provided on an external surface. In any event, the light sources 132, 134 can be provided on opposite sides of the viewing aperture 118, or can be disposed outwardly from the viewing aperture 118. The light sources 132, 134 can be disposed within lighting recesses 136, 138 that are formed in the housing 102. As depicted, the lighting recesses 136, 138 can be positioned within the recess walls 130a-b, which can allow light emitted from the light sources 132, 134 to be generally directed away from viewing aperture 118. The light sources 132, 134 and lighting recesses 136, 138 can be configured such that the light sources can be removable and replaceable.

The light sources 132, 134, and lighting recesses 136, 138 can be oriented with respect to the housing 102 such that the light emitted therefrom has an angle from about 35 degrees to about 55 degrees with respect to the viewing axis 123. As such, the recess walls 130a-b have an angle of about 35 degrees to about 55 degrees with respect to the base surface 129.

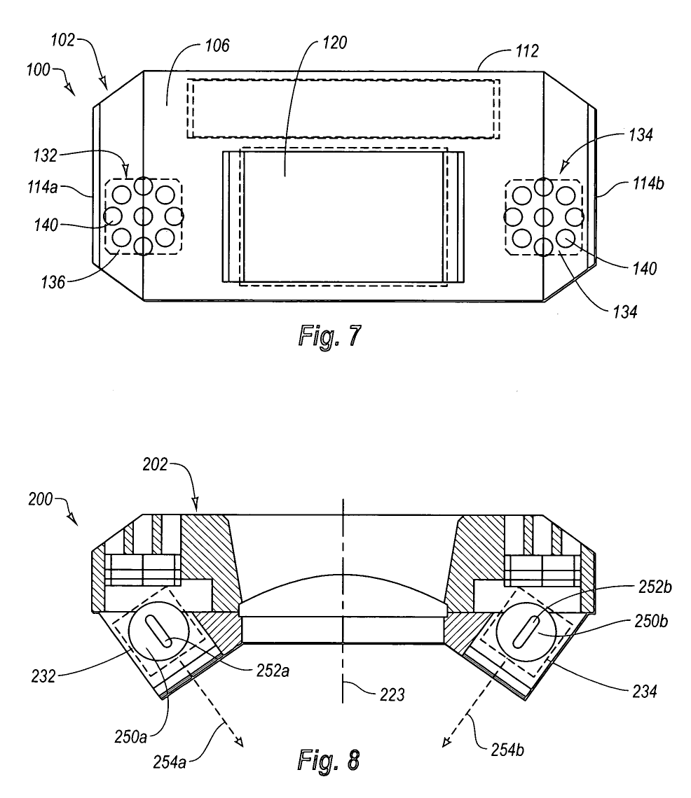

As shown in FIG. 7, each light source 132, 134 can include at least one LED 140. As shown, each light source 132, 134 includes nine LEDs 140, which can be comprised of a plurality of white LEDs and a plurality of blue LEDs and/or red LEDs. Optionally, the white and colored LEDs are provided in a ratio of about 1:1. Moreover, the light sources 132, 134 can be configured as described herein.

Optionally, each light source 132, 134 can be in optical communication with a diffuser 135a-b (FIG. 6). As such, the diffusers 135a-b can be disposed within or over the lighting recesses 136, 138. The diffusers 135a-b can blend the light emitted from the plurality of LEDs 140. Alternatively, a collimator (not shown) can be used.

In one embodiment, each light source 132, 134 can be configured to be cooled during use. That is, the LEDs 140 can be thermal communication with a cooling device or cooling structure so that any heat generated by the LEDs and/or associated components can be dissipated. This can be beneficial for keeping the housing 102 at a temperature suitable for touching or orienting the lighting device 100 proximate to a person's skin. A cooling structure can be provided in the form of at least one air inlet channel 139a-b that is in fluid communication with each light source 132, 134. The air channels 139a-b can allow air to flow in and/or out of the lighting device 100 so as to cool the light source 132, 134. As shown, an air channels 139a-b can be oriented in each front surface 104a-b so as to cool a front portion of the light source 132, 134. Also, the housing 102 can include a plurality of air vents 140a-b that can allow air to cool a back portion of each light source 132, 134. The air channels 139a-b and air vents 140a-b can allow for heat to be dissipated from the housing 102. Moreover, a portion of the air channels 139a-b and air vents 140a-b can be in fluid communication so that air entering the housing via air channel 139a can exit via air vent 140a.

In one embodiment, the cooling structure can include a heat transfer element so that heat can be dissipated. As shown, each light source 132, 134 includes a heat transfer element in the form of a heat sink 144a-b. The heat sinks 144a-b can be configured to include fins or other structures that increase the surface area for heat to be dissipated into the air flowing through the air channels 139a-b and/or air vents 140a-b.

In one embodiment, a fan 146a-b is disposed between the air channels 139a-b and the air vents 140a-b. For example, fan 146a is disposed between the air channel 139 and the air vent 140. This allows air to be forced through the housing 102 so as to cool the light sources 132, 134 as well as the housing 102 or other components.

FIG. 8 illustrates an embodiment of a lighting device 200 that is configured to allow the angle of the emitted light 254 to be adjustable with respect to the viewing axis 223. The ability to adjust the angle of the emitted light 254 can allow for a user to adjust the incident angle depending on the distance of an object being illuminated from the lighting device 200. Also, this allows for the angle to be adjusted so that the color of the object can be viewed with diffusely reflected light and not spectrally reflected light.

Accordingly, the lighting device 200 can include a housing 202 that is coupled to the light sources 232, 234 in a manner that allows for the angle of incidence of the emitted light 254a-b to be changed. Also, each light source 232, 234 can include a knob 250a-b, that allows the angle of the emitted light 254a-b to be manually changed. This can include each knob 250a-b to include an angle indicator 252a-b so that the angle of the emitted light 254a-b can be set relative to the viewing axis 223. Optionally, each knob 250a-b can include markings (not shown) that identify the angle of incidence of the emitted light 254a-b relative to the viewing axis 223.

While a knob 250a-b is shown for each light source 232, 234, a single adjustment mechanism (not shown) can be employed. Alternatively, other angle adjustment mechanisms (not shown) can be employed in order to adjust the angle of incidence of the emitted light 254a-b. Also, the angle adjustment mechanism(s) can be motorized or manually adjusted. Various other modifications can be made in order to obtain a lighting device where the direction of the emitted light can be adjusted as desired or needed.

In accordance with the foregoing, an embodiment of a lighting device can include a housing having a viewing axis and at least one light source. The light source can include at least one LED, and be coupled with the housing. The light source can be configured to emit light having a spectrum that approximates a noon-day sunlight spectrum that is emitted at an angle of from about 15 degrees to about 75 degrees with respect to the viewing axis. More preferably, the angle is from about 25 degrees to about 65 degrees, even more preferably from about 35 degrees to about 55 degrees, and most preferably about 45 degrees.

Additionally, a lighting device can be configured to use various power supplies in order to operate the light sources. As such, the lighting device can be configured to be electronically coupled with an external power source and/or include an internal power source. This can include a power cord for connecting to an external power supply. Also, a battery, which may be a rechargeable battery, can be used for powering the light source. A capacitor could also be used. Various well-known electronics and/or components for supplying power to a light can be employed in accordance with the present invention. Moreover, the lighting device can be configured so that the amount of power supplied to the light source can be adjusted, which can include any well known device for adjusting the current supplied to the light source.

V. Using Simulated Noon-Day Sunlight

One embodiment of the present invention includes using simulated noon-day sunlight emitted from a light source comprised of LEDs. Such uses can include illuminating an object with LED light that simulates the noon-day sunlight spectrum. The noon-day sunlight spectrum can be advantageous for analyzing the color of a material, or providing light that may be beneficial for an organism. Also, the use of LEDs allows noon-day sunlight to be simulated in instances previously unavailable. In part, this is because traditional fluorescent lights may have been problematic by requiring long warm-up times and generating too much heat.

In one embodiment, the simulated noon-day sunlight emitted from a light source comprised of LEDs can be used in the dental arts. Simulated noon-day sunlight can be advantageous for viewing and analyzing the color of teeth and/or dental restorative materials so that an accurate and reproducible color can be achieved. This can be useful for comparing the color of different dental restorative materials, or comparing the color of a restorative material with a patient's teeth. Also, the LEDs can be positioned relatively close to a patient's mouth and handled by a dental professional without being too hot. This can allow a dental professional to work closely with a patient's mouth without compromising comfort.

For example, the lighting device can be held relatively close to a patient's teeth. The color of a restorative material, such as ceramic or composite, used to repair teeth can be shade matched against the patient's own teeth. This can provide a more accurate process for shade taking, and thereby ensuring the correct color of the restorative material is being used to repair the patient's teeth. The patient, a technician, dentist, or support apparatus can hold the lighting device as required.

Similarly, the lighting device can be used in the medical arts. Accordingly, a medical professional can use the simulated noon-day sunlight during examinations and treatments. The light can be useful for examining eyes, skin, mucosa, ears, nostrils, and the like. This can include analyzing the color of such features. Additionally, the lighting device can be used to illuminate a wound, a wound being surgically repaired, a subject of a surgical or corrective procedure, and the like. Also, the lighting device can be configured as a medical scoping device, which can be capable of being inserted inside of a patient for surgery, colonoscopies, and the like.

Additionally, the lighting device can be used in cosmetology. This can allow for the color of various cosmetic products, such as makeup, hair dye, nail polish, and the like, to be analyzed in many different settings. Typically, the lights used to illuminate cosmetics do not allow for an accurate representation of color. As such, the simulated noon-day sunlight can be used to ensure correct colors are used for particular skin tones and hair colors.

The ability to generate simulated noon-day sunlight can be applied in many other industries for color analysis, visual observations, supplying light for stimulating life functions, and the like. For example, this can allow for the lighting device to be used in textile and manufacturing industries in order to produce articles having correct colors and to match colors of different materials. Also, the lighting device can be used to simulate daylight for agricultural uses in growing plants and flowers, which can also aid in analyzing the colors thereof. The lighting device can be used in instances where artificial light is needed in the absence of UV and/or IR light. For example, a subject needing artificial light can include works of art, paintings, photographs, cell cultures, subjects susceptible to IR and/or UV light damage, and the like.

The present invention can also be useful in photography and/or macrophotography applications as well as video recording applications. The lighting device can be used in association with a camera in order to illuminate a subject being photographed or recorded. As such, lighting device can be attached to or integrally formed with a camera. Also, the lighting device can be used to observe and analyze the color of a photograph.

In one embodiment, the present invention includes a method of analyzing color of different materials. The color analysis can be performed by viewing a first color of the first composition and a second color of the second composition under the light beam. Such a method can include illuminating a first composition and a second composition with at least one light source in accordance with the present invention. Briefly, the light source can include at least one LED, and can be configured to emit a light beam having a spectrum that approximates a noon-day sunlight spectrum. This can be especially beneficial for distinguishing or comparing colors when the first composition is different from the second composition, such as a dental restorative material and a tooth. The first color can then be compared with the second color under the simulated noon-day sunlight.

Additionally, the method of color analysis or comparison can include any of the following: (a) positioning the first composition adjacent to the second composition so that the first color and second color can be viewed simultaneously; (b) positioning the first composition and second composition at a predefined distance from at least one light source; (c) adjusting the angle of the light source with respect to the first composition and the second composition, wherein the angle of the light source is from about 15 degrees to about 75 degrees with respect to the a viewing axis in the lighting a device and/or with respect to the first composition and second composition; (d) observing the first composition and second composition through a viewing aperture or along a viewing axis; (e) adjusting the magnification of an image viewed through the viewing aperture; and (f) adjusting the focus of the image viewed through the viewing aperture. Various other well-known procedures used in color analysis and comparisons can also be performed with the lighting device of the present invention.

In one embodiment, the present invention includes a method of illuminating an object. Such a method can include obtaining a lighting device in accordance with the present invention. A viewing axis of the lighting device can be positioned substantially orthogonal with respect to an object to be illuminated so that the light emitted from the lighting device is directed at the object at about 15 degrees to about 75 degrees with respect to the viewing axis when the object is at about 90 degrees. Alternatively, the angle of incidence can be varied as described herein. The object can then be illuminated with at least one light source, and viewed along the viewing axis.

Additionally, in any of the embodiments of the invention described herein, the lighting device can be positioned at a distance from the object. As such, the distance can be a predetermined distance depending on various factors, which include the following: (a) temperature sensitivity of the illuminated object; (b) size of object; (c) angle of incidence; and (d) purpose of illumination. For example, in the instance the object being viewed is a patient's teeth the distance of the lighting device from the teeth can range from about 15 mm to about 100 mm, more preferably from about 25 mm to 80 mm, and most preferably from about 35 to 70 mm from the patient's teeth. Additionally, the working distance can correspond to the focal length of the lens and/or angle of incidence. Moreover, the working distance can be scaled-up in size for other applications.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A lighting device comprising:
a housing having a viewing axis; and
at least one light source, comprised of at least one LED, coupled with the housing and being configured to emit light having a spectrum that approximates a noon-day sunlight spectrum, the emitted light being oriented from about 15 degrees to about 75 degrees with respect to the viewing axis.

2. A lighting device as in claim 1, wherein the approximated noon-day sunlight spectrum is characterized as being from about 5200 Kelvin to about 6600 Kelvin.

3. A lighting device as in claim 2, wherein the approximated noon-day sunlight spectrum is characterized as being about 5500 Kelvin.

4. A lighting device as in claim 1 wherein the emitted light is oriented at about 35 degrees to about 55 degrees with respect to the viewing axis.

5. A lighting device as in claim 1, wherein the light source is comprised of at least one white LED.

6. A lighting device as in claim 5, wherein the light source is further comprised of at least one of a red LED or a blue LED.

7. A lighting device as in claim 1, wherein the approximated noon-day sunlight spectrum is substantially the same as shown in FIG. 2, FIG. 4A, or FIG. 4B.

8. A lighting device as in claim 1, further comprising a second light source coupled to the housing, the second light source having at least one LED and being configured to emit light having a spectrum that approximates a noon-day sunlight spectrum, the emitted light being oriented from about 15 degrees to about 75 degrees with respect to the viewing axis.

9. A lighting device as in claim 1, wherein the housing further comprises a viewing aperture containing the viewing axis.

10. A lighting device as in claim 9, wherein the viewing aperture includes at least one of the following:
an aperture wall defining the viewing aperture, the aperture wall having a grey color;
a rear surface surrounding the viewing aperture and in communication with the aperture wall, the rear surface having a grey color;
a lens with a concave surface;
a lens with a convex surface;
a magnifying lens;
a magnifying mechanism configured to adjust magnification of the object;
a focusing mechanism configured to focus the object;
a reducing lens;
at least one reflective material to inhibit specular reflections from the object; or
an aperture wall having an inward taper from the rear surface.

11. A lighting device as in claim 1, wherein the light source has at least one of the following:
a diffuser;
a collimator;
a filter that conditions the emitted light to approximate the noon-day sunlight spectrum;
at least one white LED and at least one blue LED;
at least one white LED, at least one blue LED, and at least one red LED;
at least one white LED and at least one red LED;
a current tuner mechanism;
an angle adjusting mechanism; or
a cooling device comprised of at least one of the following:
at least one air inlet channel;
at least one air outlet channel;
a heat sink;
a fan; or
a plurality of cooling fins.

12. A lighting device as in claim 1, wherein the housing includes at least one of the following:
a viewing aperture containing the viewing axis;
a battery for powering the light source;
electronics configured to measure power provided by the battery;
a power cord for connecting to a power supply;
a mechanism for adjusting the angle of the light source; or
a mechanism for adjusting the current supplied to the light source.

13. A method of analyzing color of different materials, the method comprising:
illuminating a first composition and a second composition with at least one light source having at least one LED, the light source being configured to emit a light beam having a spectrum that approximates a noon-day sunlight spectrum, wherein the first composition is different from the second composition;
viewing a first color of the first composition and a second color of the second composition under the light beam; and
comparing the first color with the second color.

14. A method as in claim 13, wherein the approximated noon-day sunlight spectrum is characterized as being from about 5200 Kelvin to about 6600 Kelvin.

15. A method as in claim 13, wherein the light source is comprised of at least one white LED, at least one red LED, and/or at least one blue LED.

16. A method as in claim 13, wherein the first composition is a dental restorative material and the second color is a dental patient's tooth.

17. A method as in claim 13, further comprising at least one of the following:
positioning the first composition adjacent to the second composition so that the first color and second color can be viewed simultaneously;
positioning the first composition and second composition at a predefined distance from the light source;
adjusting the angle of the light source with respect to the first composition and the second composition, wherein the angle of the light source is from about 15 degrees to about 75 degrees with respect to a viewing axis and the first composition and second composition are both at about 90 degrees with respect to the viewing axis;
observing the first composition and second composition through a viewing aperture;
adjusting the magnification of an image viewed through the viewing aperture; or
adjusting the focus of the image viewed through the viewing aperture.

18. A method of illuminating an object, the method comprising:
obtaining a lighting device comprised of at least one light source disposed in a housing, the light source being comprised of at least one LED, the light source being configured to emit light having a spectrum that approximates a noon-day sunlight spectrum, the emitted light being oriented from about 15 degrees to about 75 degrees with respect to a viewing axis in the housing.
positioning the viewing axis substantially orthogonal with an object so that the emitted light is directed at the object at about 15 degrees to about 75 degrees when the object is at about 90 degrees with respect to the viewing axis;
illuminating the object with the light source; and
viewing the object along the viewing axis.

19. A method as in claim 18, wherein the noon-day sunlight spectrum is characterized as being from about 5200 Kelvin to about 6600 Kelvin.

20. A method as in claim 18, wherein the light source is comprised of at least one white LED, at least one red LED, or at least one blue LED.

21. A method as in claim 18, wherein the object is at least one of the following:
a wound;
a wound being surgically repaired;
a subject of a surgical procedure;
skin;
an eye;
a tooth;
a dental restorative;
hair;
a textile article of manufacture;
a plant;
a flower;
a subject needing artificial light;
a work of art;
a painting;
a subject of a photograph;
a cell culture; or
a subject susceptible to IR and/or UV light damage.
